(19) United States
(12) Patent Application Publication
(10) Pub. No.: US 2024/0048838 A1
(43) Pub. Date: Feb. 8, 2024

(54) DISPLAY APPARATUS, DISPLAY CONTROL METHOD, AND PROGRAM

(71) Applicant: SONY GROUP CORPORATION, TOKYO (JP)

(72) Inventors: CHIHIRO SUGAI, TOKYO (JP); HIROAKI SHINOHARA, TOKYO (JP); ASAKO TOMURA, TOKYO (JP); SHIGEKUNI DEWA, TOKYO (JP)

(21) Appl. No.: 18/255,948

(22) PCT Filed: Oct. 28, 2021
(86) PCT No.: PCT/JP2021/039821

§ 371 Date: Jun. 5, 2023

(30) Foreign Application Priority Data
Dec. 16, 2020 (JP) 2020-208227

(51) Int. Cl. H04N 23/60; H04N 7/15; G09G 5/14; G09G 5/38; G03B 11/04; G06F 3/01

(52) U.S. Cl. CPC H04N 23/60; H04N 7/15; G09G 5/14; G09G 5/38; G03B 11/045; G06F 3/013

(57) ABSTRACT

An image catching, from the vicinity of a front surface, an eye gaze of a user closely looking at a display area is displayed with less sense of strangeness.

[Solving Means]

Provided is a display apparatus that includes a first display section including a first display area having transparency, a second display section including a second display area disposed in such a manner as to be visible through the first display area, and an image taking section disposed between the first display section and the second display section to enable an image of a user facing the first display area to be taken via the first display area.

### TECHNICAL FIELD

The present disclosure relates to a display apparatus, a display control method, and a program.

### BACKGROUND ART

In recent years, systems for realizing communication using taken images have come into widespread use. Further, in regard to the systems as described above, many technologies for improving convenience of users have been proposed.

For example, PTL 1 discloses an apparatus that includes an image taking section disposed on a rear surface of a display for which transparency can be increased. In the apparatus, with the transparency of the display increased, an image of a person facing the display is taken. Such an apparatus allows an image of a user closely looking at the display to be taken from the vicinity of a front surface of the display. This is expected to be effective in matching the eye gaze of the user with the eye gaze of a person communicating with the user via the apparatus.

### CITATION LIST

### Patent Literature

PTL 1
Japanese Patent Laid-open No. Hei 7-143469

### SUMMARY

### Technical Problem

However, the apparatus disclosed in PTL 1 alternately repeats a period in which the transparency of the display is increased to allow an image of a person to be taken and a period in which light is emitted to allow an image of the person communicating with the user and the like to be displayed. Accordingly, the apparatus disclosed in PTL 1 is likely to make the person closely looking at the display feel a sense of strangeness.

### Solution to Problem

According to an aspect of the present disclosure, there is provided a display apparatus that includes a first display section including a first display area having transparency, a second display section including a second display area disposed in such a manner as to be visible through the first display area, and an image taking section disposed between the first display section and the second display section to enable an image of a user facing the first display area to be taken via the first display area.

Further, according to another aspect of the present disclosure, there is provided a display control method that includes controlling, by a processor, display of an image by a display apparatus including a first display section including a first display area having transparency, a second display section including a second display area disposed in such a manner as to be visible through the first display area, and an image taking section disposed between the first display section and the second display section to enable an image of a user facing the first display area to be taken via the first display area, and controlling the display of the image by the display apparatus further includes causing a face image to be displayed in the first display area and near a center of an angle of view of the image taking section.

Further, according to another aspect of the present disclosure, there is provided a program that causes a computer to implement a display control function for controlling display of an image by a display apparatus including a first display section including a first display area having transparency, a second display section including a second display area disposed in such a manner as to be visible through the first display area, and an image taking section disposed between the first display section and the second display section to enable an image of a user facing the first display area to be taken via the first display area, and that causes the display control function to display a face image in the first display area and near a center of an angle of view of the image taking section.

### BRIEF DESCRIPTION OF DRAWINGS

FIG. 1 is a diagram for describing features of a display apparatus 10 according to an embodiment of the present disclosure.

FIG. 2 is a block diagram depicting a functional configuration example of the display apparatus 10 according to the embodiment.

FIG. 3 is a diagram for describing display control performed in a case where a second display area 125 according to the embodiment includes an electronic blind.

FIG. 4 is a diagram for describing display control performed in a case where the second display area 125 according to the embodiment includes the electronic blind.

FIG. 5 is a diagram for describing display control performed in a case where the second display area 125 according to the embodiment includes a non-transparent material.

FIG. 6 is a diagram for describing a shielding section 160 according to the embodiment.

FIG. 7 is a diagram for describing control of a display position of a face image based on the position of an image taking section 130 according to the embodiment.

FIG. 8 is a diagram for describing display control based on a speech according to the embodiment.

FIG. 9 is a diagram for describing display control based on a speech according to the embodiment.

FIG. 10 is a diagram for describing control of the display position of the face image based on the eye gaze of a user U according to the embodiment.

FIG. 11 is a diagram for describing correction of the face image performed by a display control section 140 according to the embodiment.

FIG. 12 is a diagram for describing image taking control according to the present embodiment, according to the embodiment.

FIG. 13 is a diagram for describing image taking control according to the present embodiment, according to the embodiment.

FIG. 14 is a flowchart illustrating an example of a flow of processing by the display apparatus 10 according to the embodiment.

FIG. 15 is a block diagram depicting a hardware configuration example of a control apparatus 90 according to the embodiment.

### DESCRIPTION OF EMBODIMENT

A preferred embodiment of the present disclosure will be described below in detail with reference to the accompanied drawings. Note that components having substantially the same functional configurations in the present specification and drawings are denoted by the same reference signs and duplicate description of the components are omitted.

Note that the description is given in the following order.
1. Embodiment
   1.1. Overview
   1.2. Functional Configuration Example of Display Apparatus 10
   1.3. Details of Second Display Area
   1.4. Details of Display Control
   1.5. Details of Image Taking Control
   1.6. Flow of Processing
   1.7. Applied Example
2. Hardware Configuration Example of Control Apparatus 90
3. Conclusion

### 1. Embodiment

### <<1.1 Overview>>

As described above, in recent years, systems for realizing communication using taken images have come into widespread use. The systems as described above include, for example, various video chat systems and the like.

Further, many study results have been reported indicating that matching the eye gaze of a person with that of another person communicating with him/her is important in order to realize better communication.

However, some apparatuses used to take and display images may have difficulty in matching the eye gaze of one user with that of another user.

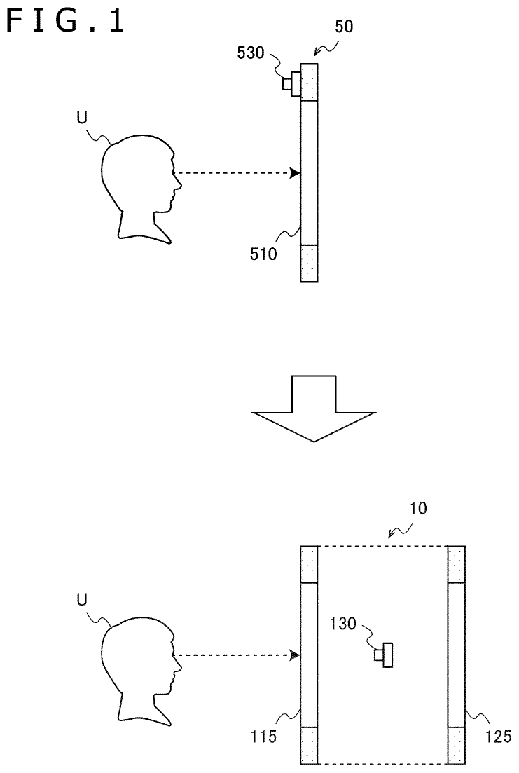

FIG. 1 is a diagram for describing features of a display apparatus 10 according to an embodiment of the present disclosure.

Here, first, a configuration of a typical image taking and display apparatus 50 will be illustrated in order to describe the effects produced by the display apparatus 10 according to the present embodiment.

The image taking and display apparatus 50 depicted in an upper stage of FIG. 1 includes a display section 510 for displaying images of a person communicating with the user U via the apparatus and the like and an image taking section 530 for taking images of the user U using the apparatus.

Further, in the image taking and display apparatus 50, the image taking section 530 is characterized by being disposed at a bezel section formed around the display section 510. In the example illustrated in the upper stage of FIG. 1, the image taking section 530 is disposed at the bezel section in the upper portion of the display section 510.

Here, in a case where the user U communicates with a person whose image is displayed on the display section 510 while closely looking at the image of the person, the image taking section 530 is unable to catch the eye gaze of the user U from the front and takes a downward view of the user U.

Accordingly, in a case as described above, an apparatus used by the person communicating with the user U displays images depicting the user U taking a downward look, making it difficult to match the eye gaze of the user U with the eye gaze of the person.

On the other hand, in a case where the user U looks the image taking section 530 from the front, the image taking section 530 can take images catching the eye gaze of the user U from the front.

However, in this case, the user U is unable to closely looking at images of the person displayed on the display section 510, leading to a possibility of not only a failure to match the eye gaze of the user U with that of the person but also a difficulty in communication.

Further, a phenomenon as described above may occur in cases other than communication using images.

For example, the user U is assumed to take what is generally called a selfie with use of the image taking and display apparatus 50.

In the above-described situation, in a case where the user U closely looks at images of the user U displayed on the display section 510, taking images catching the eye gaze of the user U from the front is difficult.

On the other hand, in a case where the user U closely looks at the image taking section 530, the user U has difficulty in checking images of the user U displayed on the display section 510.

Such a difficulty may occur similarly in image taking for video streaming or the like, in addition to selfie taking.

A technical concept according to an embodiment of the present disclosure is established by focus being placed on the points described above, and enables display of an image catching, from the vicinity of the front surface, the eye gaze of the user closely looking at a display area, with less sense of strangeness.

Accordingly, the display apparatus 10 according to an embodiment of the present disclosure includes a first display section 110 including a first display area 115 having transparency and a second display section 120 including a second display area 125 disposed in such a manner as to be visible through the first display area 115, as depicted in a lower stage of FIG. 1.

Further, the display apparatus 10 according to an embodiment of the present disclosure includes an image taking section 130 disposed between the first display section 110 and the second display section 120 to enable an image of the user U against the first display area 115 to be taken via the first display area 115.

The configuration as described above enables display of an image catching, from the vicinity of the front surface, the eye gaze of the user closely looking at an image displayed in the first display area 115 or the second display area 125.

Further, the configuration as described above allows an image catching, from the vicinity of the front surface, the eye gaze of the user U or the person communicating with the user U with use of another display apparatus 10 to be displayed in the first display area 115 that is closely looked at by the user U.

This enables realization of communication with the eye gaze of the user matched with the eye gaze of the communication partner, enables taking of an image catching the eye gaze of the user from the front, with the taken image of the user being checked by the user, and enables other operations.

Furthermore, unlike the apparatus disclosed in PTL 1, the display apparatus 10 according to the present embodiment need not alternately repeat a period in which the transparency of the display is increased to allow an image of a person to be taken and a period in which light is emitted to allow an image of a person corresponding to a communication partner or the like to be displayed, thus enabling implementation of image display providing a less sense of strangeness.

A functional configuration for implementing the above-described results will be described below in more detail.

### <<1.2. Functional Configuration Example>>

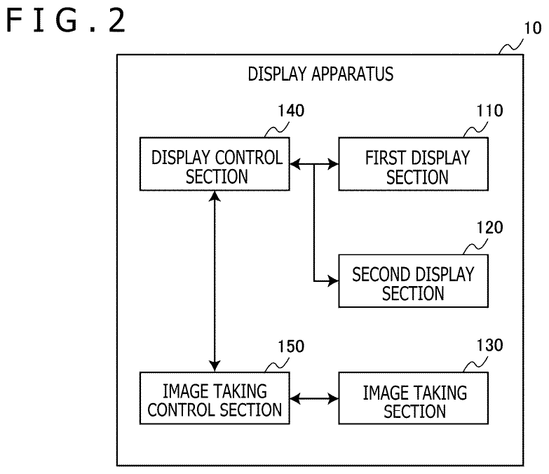

FIG. 2 is a block diagram depicting a functional configuration example of the display apparatus 10 according to the present embodiment. The display apparatus 10 according to the present embodiment may be implemented as, for example, a personal computer, a smartphone, a tablet, or the like.

As depicted in FIG. 2, the display apparatus 10 according to the present embodiment may include the first display section 110, the second display section 120, the image taking section 130, the display control section 140, and the image taking control section 150.

### (First Display Section 110)

The first display section 110 according to the present embodiment includes the first display area 115 (area in which an image is displayed) having transparency, the bezel section, and the like.

The first display area 115 according to the present embodiment is formed using, for example, a TOLED (Transparent Organic Light-Emitting Device), a spatial projection technology, and the like.

### (Second Display Section 120)

The second display section 120 according to the present embodiment includes the second display area 125 (area in which an image is displayed), the bezel section, and the like.

The second display area 125 according to the present embodiment may be formed using a transparent material or a non-transparent material.

The second display area 125 according to the present embodiment can be formed using, for example, an electronic blind (light control glass), a TOLED, an OLED, an LCD (Liquid Crystal Display), or the like.

Note that a feature of the second display section 120 according to the present embodiment is that the second display area 125 is disposed in such a manner as to be visible through the first display area 115 as depicted in the lower stage of FIG. 1.

The disposition as described above allows an image displayed in the first display area 115 to be rendered with high quality, enabling communication with a sense of reality and the like to be realized.

Further, the disposition as described above enables reproduction of black, which is difficult to achieve with only the TOLED.

Furthermore, the disposition as described above enables implementation of a superimposition application and UI representation that provide a depth and use two physical layers.

### (Image Taking Section 130)

The image taking section 130 according to the present embodiment takes images of the user and the like. An image taken by the image taking section 130 may be displayed on an apparatus used by a person who communicates with the user via the image.

Note that a feature of the image taking section 130 according to the present embodiment is that the image taking section 130 is disposed between the first display section 110 and the second display section 120 to enable an image of the user facing the first display area 115 to be taken via the first display area 115 as depicted in the lower stage of FIG. 1.

The disposition as described above enables taking of an image catching, from the vicinity of the front surface, the eye gaze of the user closely looking at the image displayed in the first display area 115.

Further, the disposition as described above allows the image displayed in the first display area 115 to hide the presence of the image taking section 130 from the user, enabling image taking giving less sense of strangeness to the user.

### (Display Control Section 140)

The display control section 140 according to the present embodiment controls display of images performed by the first display section 110 and the second display section 120.

Various processors implement functions of the display control section 140 according to the present embodiment. The details of functions of the display control section 140 according to the present embodiment will separately be described.

### (Image Taking Control Section 150)

The image taking control section 150 according to the present embodiment controls image taking performed by the image taking section 130.

Various processors implement functions of the image taking control section 150 according to the present embodiment. The details of functions of the image taking control section 150 according to the present embodiment will separately be described.

The functional configuration example of the display apparatus 10 according to the present embodiment has been described above. Note that the functional configuration described above using FIG. 2 is merely illustrative, and the functional configuration of the display apparatus 10 according to the present embodiment is not limited to such an example.

For example, in a case where the display apparatus 10 according to the present embodiment is adopted for the communication system as described above, the display apparatus 10 may further include a communication section that communicates with another apparatus.

Further, the display apparatus 10 may further include an operation section for receiving operations performed by the user, a sound output section for outputting sound, and the like.

The functional configuration of the display apparatus 10 according to the present embodiment can flexibly be changed according to specifications and operation.

### <<1.3. Details of Second Display Area>>

Now, the second display section 120 according to the present embodiment will be described in further detail by taking a specific example.

As described above, the second display area 125 of the second display section 120 according to the present embodiment may be formed using a transparent material or a non-transparent material.

Rendition of images with different tones can be implemented by selection of a material adopted for the second display area 125.

For example, the second display area 125 according to the present embodiment may be formed using an electronic blind or a TOLED for which transparency can be adjusted.

In this case, by controlling the transparency of the second display area 125, the display control section 140 can improve the quality of images displayed in the first display area 115.

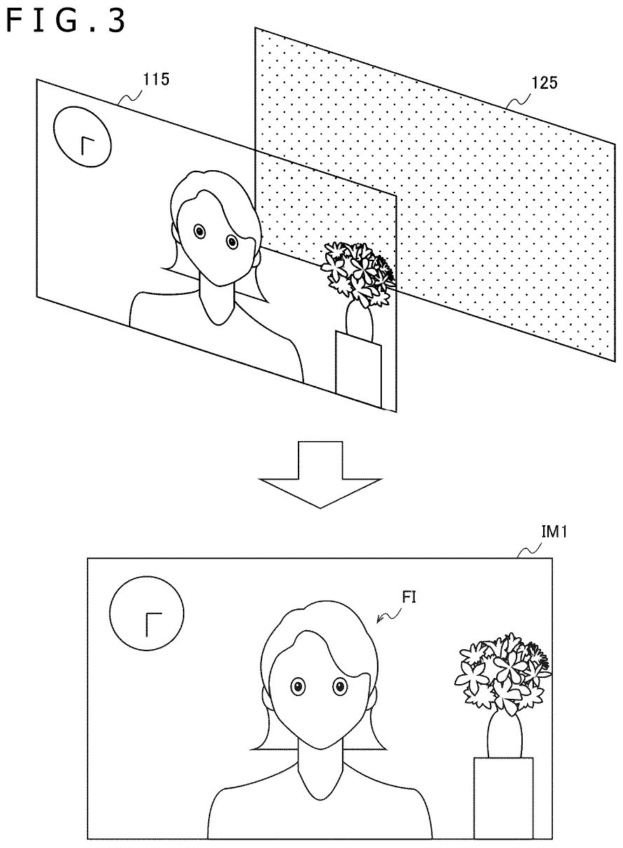

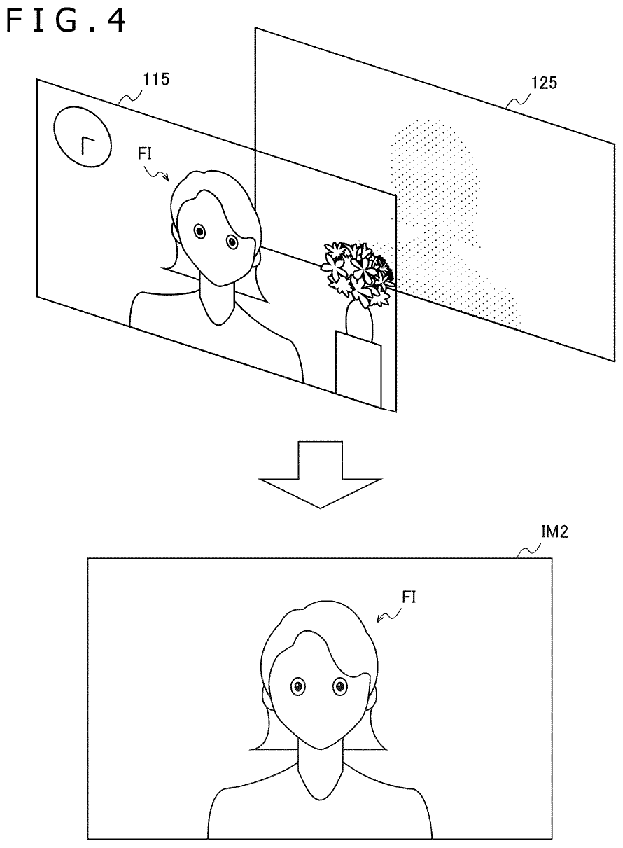

FIGS. 3 and 4 are figures for describing display control performed in a case where the second display area 125 according to the present embodiment includes an electronic blind.

In a case of an example illustrated in an upper stage of FIG. 3, the display control section 140 performs energization control to cause an image including a face image FI to be displayed in the first display area 115, while reducing the transparency throughout the second display area 125.

Note that here, face images according to the present embodiment include images each obtained by taking an image of the structure of the face of a living thing and images each generated by mimicking the structure of the face of a living thing.

As an example, the face image according to the present embodiment may be an image corresponding to the face of a subject communicating, via images, with the user using the display apparatus 10.

The communicating subject described above includes another person communicating with the user, particularly a speaker having conversations with the user.

Further, the communicating subject described above may include a character on an application (for example, an agent or the like).

Further, as another example, the face image according to the present embodiment may be an image of the face of the user taken by the image taking section 130.

The control as described above allows the user to view a superimposed image IM1 clearly depicting all of the face image FI and a background image as depicted in a lower stage of FIG. 3.

On the other hand, in a case of an example illustrated in an upper stage of FIG. 4, the display control section 140 performs energization control to reduce the transparency only in an area of the second display area 125 corresponding to an area of the first display area 115 in which the face image FI is displayed.

The control as described above allows the user to view a superimposed image IM2 clearly depicting only the face image FI and making the background image blurry as depicted in a lower stage of FIG. 4.

The display control example of a case in which the second display area 125 according to the present embodiment is formed using a transparent material has been described above. Note that, in a case where the face image FI is not displayed in the first display area 115, the presence of both display areas can be eliminated by performing control in such a manner as to maximize the transparency throughout the second display area 125 (that is, not to perform energization).

Now, a specific example of a case in which the second display area 125 according to the present embodiment includes a material such as an OLED or an LCD with no transparency will be described.

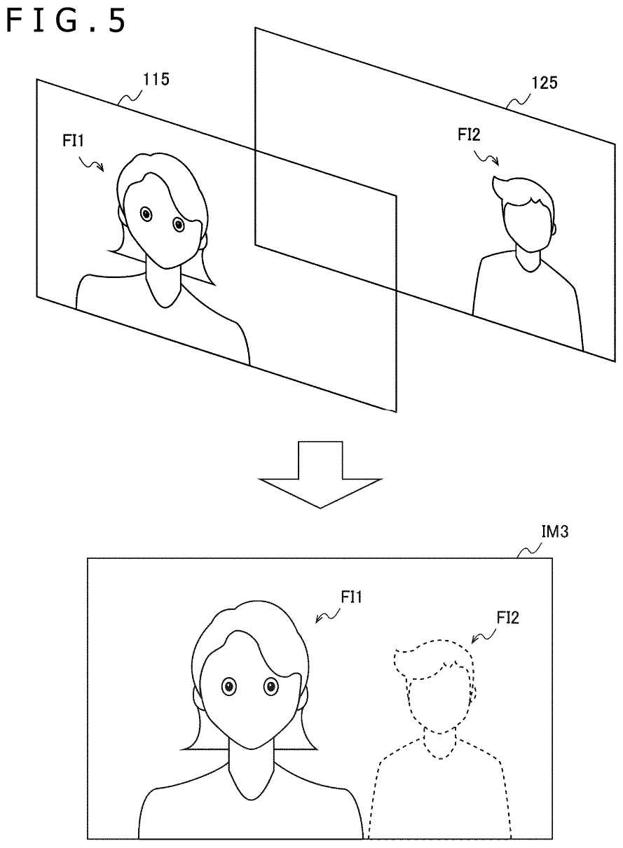

FIG. 5 is a figure for describing display control performed in a case where the second display area 125 according to the present embodiment is formed using a non-transparent material.

In a case of an example illustrated in an upper stage of FIG. 5, the display control section 140 causes a face image FI1 to be displayed in the first display area 115, while causing a face image FI2 that is different from the face image FI1 to be displayed in the second display area 125.

The control as described above allows the user to view a superimposed image IM3 clearly depicting only the face image FI1 and slightly blurrily depicting the face image FI2 as illustrated in a lower stage of FIG. 5.

In such a manner, by displaying different images in the first display area 115 and the second display area 125, the presence of the person corresponding to the face image displayed in the first display area 115 can be improved (rendition for clear presence), while the presence of the person corresponding to the face image displayed in the second display area 125 can be reduced (rendition for vague presence), or the like. Thus, creation of an image with a sense of depth can be realized.

The display control corresponding to the material used for the second display area 125 according to the present embodiment has been described above. The material used for the second display area 125 may be appropriately selected according to the specification of the application using the display apparatus 10 or the like.

However, to take a high-quality image of the user facing the first display area 115 regardless of the material used for the second display area 125, outside light except for light entering via the first display area 115 is desirably prevented from reaching an imaging element provided in the image taking section 130.

Accordingly, the display apparatus 10 according to the present embodiment may further include a shielding section 160 that shields the image taking section 130 from the outside light.

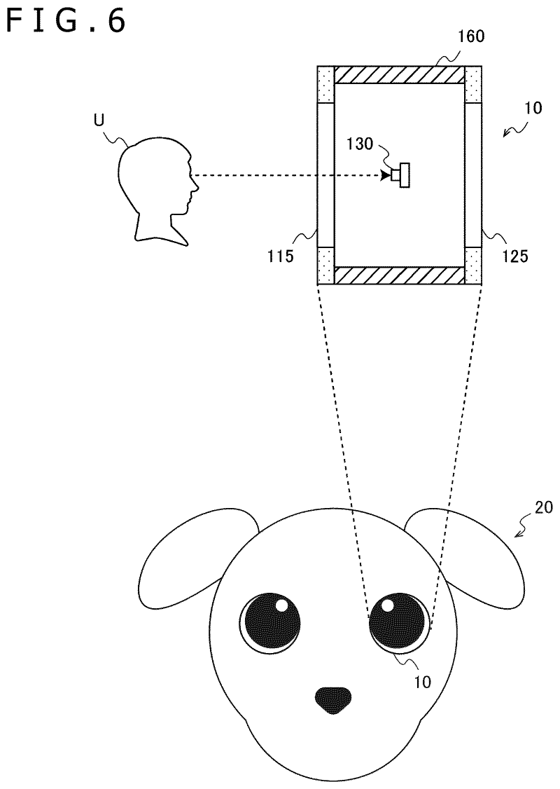

FIG. 6 is a diagram for describing the shielding section 160 according to the present embodiment. An upper stage of FIG. 6 depicts an arrangement example of the shielding section 160 formed around the image taking section 130 disposed between the first display area 115 and the second display area 125.

As depicted in an example illustrated in the upper stage of FIG. 6, the shielding section 160 according to the present embodiment is formed and arranged to shield the image taking section 130 from outside light except for light entering via the first display area 115.

Such a configuration allows outside light, causing noise, to be excluded, enabling a high-quality image of the user facing the first display area 115 to be taken.

Note that, as an example, the display apparatus 10 including the shielding section 160 may be applied to an eyeball structure of a robot 20 as depicted in a lower stage of FIG. 6. In this case, the first display area 115 displays an image corresponding to the eye or luster.

Such a configuration allows an image of the user to be taken using, as a start point, the eyeball which the user is highly likely to view directly, without the need to place a separate image taking section, for example, at a site corresponding to the nose. This enables communication and recognition processing with higher quality.

### <<1.4. Details of Display Control>>

Now, the display control performed by the display control section 140 according to the present embodiment will be described in further detail. The display control section 140 according to the present embodiment performs various types of display control to match the eye gaze of the face image caused to be displayed in the first display area 115 with the eye gaze of the user U facing the first display area 115.

For example, the display control section 140 according to the present embodiment may cause the face image to be displayed in the first display area 115 near and the center of the angle of view of the image taking section 130.

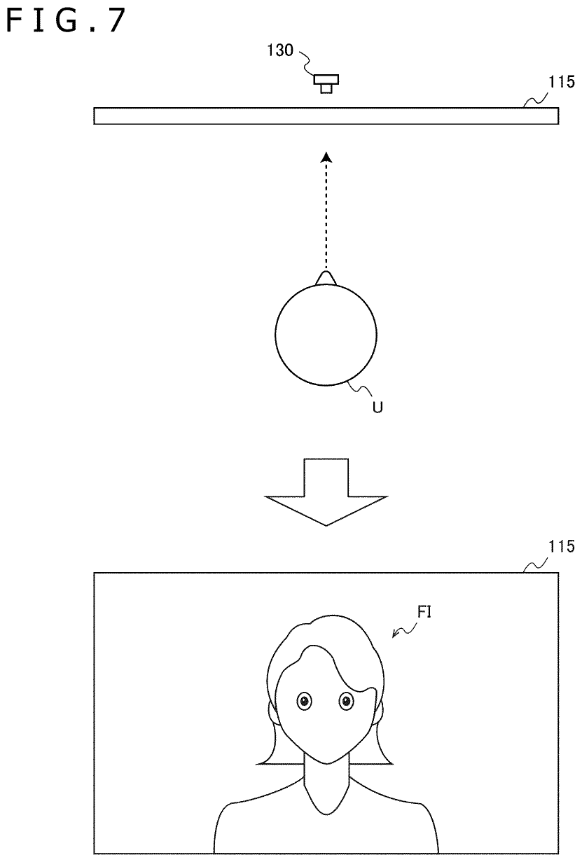

FIG. 7 is a diagram for describing the control of the display position of the face image based on the position of the image taking section 130 according to the present embodiment.

An upper stage of FIG. 7 illustrates a positional relation between the first display area 115 according to the present embodiment and the image taking section 130. As depicted in the figure, the image taking section 130 according to the present embodiment may be disposed with the center of the angle of view located near the center of the first display area 115.

Typically, the eye gaze of the user U facing the first display area 115 is assumed to be likely to be concentrated in the vicinity of the center of the first display area 115.

Accordingly, the arrangement as described above is expected to increase the possibility of allowing an image catching the eye gaze of the user U from the front to be taken.

Moreover, to further increase the possibility described above, the display control section 140 according to the present embodiment may cause the face image FI to be displayed in the first display area 115 and near the center of the angle of view of the image taking section 130 as depicted in a lower stage of FIG. 7.

Among the images displayed in the first display area 115 or the second display area 125, the user U is most likely to closely look at the face image FI. Accordingly, the display control as described above enables an effective increase in the possibility that the eye gaze of the user U matches the eye gaze of the face image FI.

Further, assumed is a case where the display apparatus 10 according to the present embodiment is used for a video chat for multiple persons. In this case, multiple face images may be caused to be displayed in the first display area 115.

However, in this case, the user U is most likely to closely look at a face image depicting the face of a speaker making a speech instead of uniformly directing the eye gaze to all the face images.

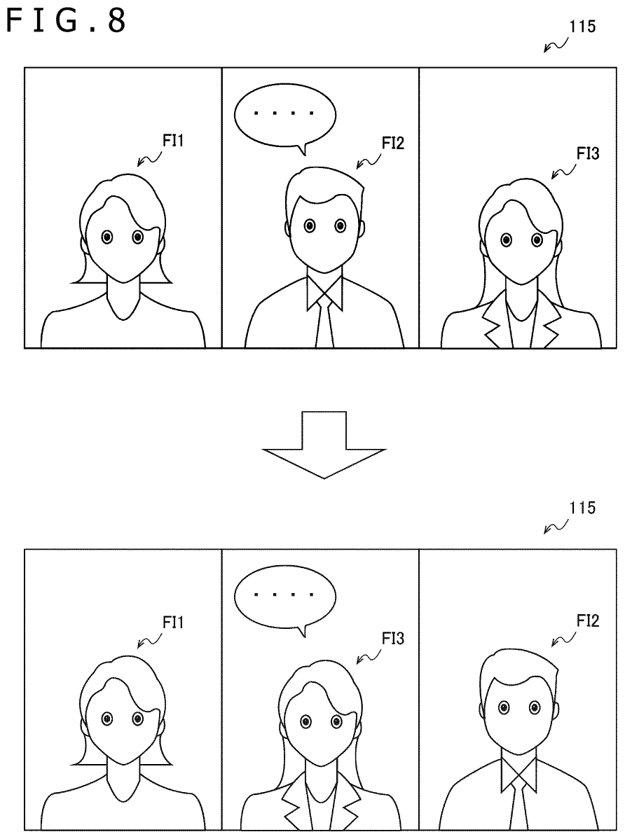

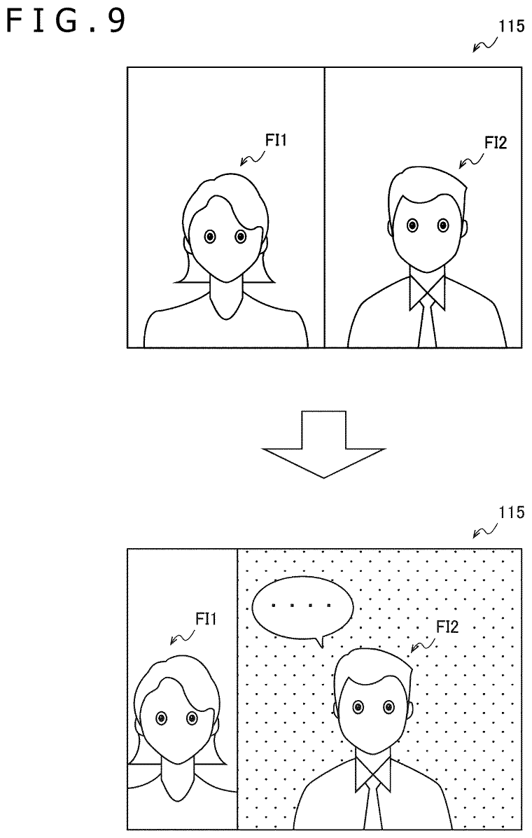

FIGS. 8 and 9 are figures for describing display control based on speeches according to the present embodiment. Note that, in FIGS. 8 and 9, the image taking section 130 is assumed to be disposed with the center of the angle of view located near the center of the first display area 115.

For example, FIG. 8 depicts three face images FI1 to FI3 being displayed in the first display area 115. The face images FI1 to FI3 may be images taken using respective display apparatuses 10 and depicting the faces of participants in a video chat.

At this time, in a case where the person corresponding to the face image FI2 is making a speech, the display control section 140 according to the present embodiment performs control in such a manner that the face image FI2 is displayed near the center of the angle of view of the image taking section, as depicted in an upper stage of FIG. 8.

On the other hand, in a case where the person corresponding to the face image FI3 is making a speech, the display control section 140 performs control in such a manner that the face image FI3 is displayed near the center of the angle of view of the image taking section, as depicted in a lower stage of FIG. 8.

In such a manner, among the multiple face images caused to be displayed in the first display area 115, the display control section 140 according to the present embodiment may cause the face image depicting the face of a speaker making a speech to be displayed near the center of the angle of view of the image taking section 130.

The control as described above enables an effective increase in the possibility that the eye gaze of the face image depicting the face of the speaker making a speech matches the eye gaze of the user facing the first display area 115.

Further, among the multiple images caused to be displayed in the first display area 115, the display control section 140 according to the present embodiment may highlight the face image depicting the face of the speaker making a speech.

For example, FIG. 9 depicts a state where the two face images FI1 and FI2 are displayed in the first display area 115. The face image FI1 and the face image FI2 may be images taken using the respective display apparatuses 10 and depicting the faces of participants in the video chat.

At this time, as depicted in an upper stage of FIG. 9, in a case where none of the participants are making a speech, the display control section 140 according to the present embodiment causes the face image FI1 and the face image FI2 to be displayed in the first display area 115 at an equivalent degree of highlighting.

On the other hand, as depicted in a lower stage of FIG. 9, in a case where the person corresponding to the face image FI2 is making a speech, the display control section 140 according to the present embodiment performs control in such a manner that the face image FI2 is highlighted compared to the face image FI1.

For example, the display control section 140 may perform control to enlarge a drawing range corresponding to the face image FI2. This is expected to be effective in causing the face image FI2 to naturally approach the center of the angle of view of the image taking section 130.

Further, for example, the display control section 140 may control one of or both the first display section 110 and the second display section 120 to highlight the drawing range corresponding to the face image FI2.

Examples of the control described above are assumed to include highlighting of a background, edges, contrast, and colors related to the face image FI2, and the like. On the other hand, the display control section 140 may relatively highlight the face image FI2 by suppressing each of the elements related to the face image FI1, described above.

Further, the display control section 140 may relatively highlight the face image FI2 by causing the face image FI1 to be displayed in the second display area 125, while causing only the face image FI2 to be displayed in the first display area 115.

The control of the display positions of the face images based on the position of the image taking section 130 has been described above with reference to specific examples.

Meanwhile, the display positions of the face images need not necessarily be controlled according to the position of the image taking section 130.

For example, the display control section 140 according to the present embodiment may cause the face image to be displayed at the position of the eye gaze of the user U on the first display area 115.

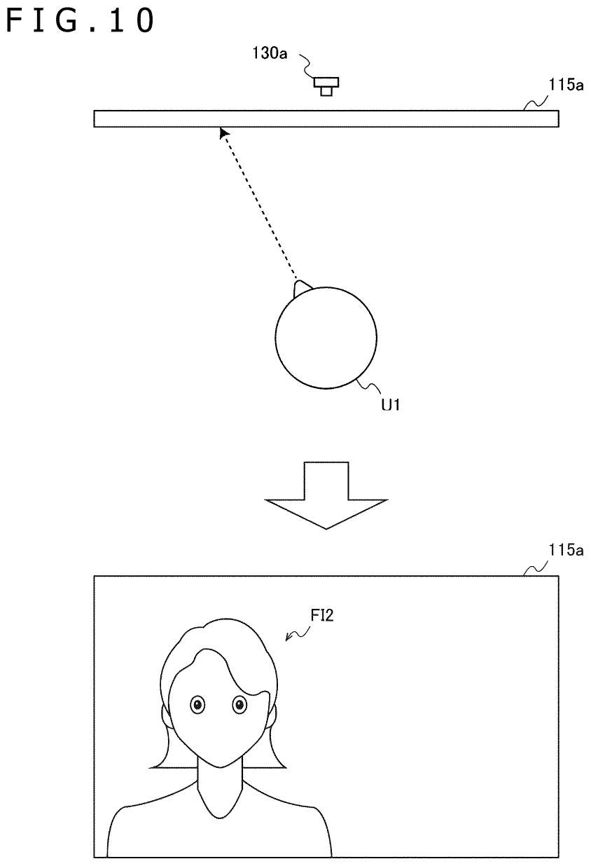

FIG. 10 is a diagram for describing the control of the display position of the face image based on the eye gaze of the user U according to the present embodiment.

For example, as depicted in an upper stage of FIG. 10, the eye gaze of a user U1 using a display apparatus 10a is assumed to be directed to the left of a first display area 115a as viewed from the user.

In this case, the display control section 140 according to the present embodiment may detect the eye gaze of the user U1 as described above and perform control in such a manner that the face image FI2 is displayed at the position of the eye gaze as depicted in a lower stage of FIG. 10. The display control section 140 may detect the eye gaze with use of various technologies widely used in the field of eye gaze detection.

Note that the face image FI2 may be an image depicting the face of a user U2 using a display apparatus 10b separate from the display apparatus 10a used by the user U1.

The control as described above enables, for the display apparatus 10a, the eye gaze of the face image FI2 displayed in the first display area 115a to accurately match the eye gaze of the user U1.

On the other hand, in a case of an example depicted in the upper stage of FIG. 10, the eye gaze of the user U1 is misaligned with the center of the angle of view of an image taking section 130a. Accordingly, in a case where no separate control is performed, a first display area 115b of the display apparatus 10b used by the user U2 would display the face image FI1 not catching the eye gaze of the user U1 from the front.

To solve the problem described above, the display control section 140 according to the present embodiment may execute processing for correcting the face image to substantially match the eye gaze of the face image with the eye gaze of the user.

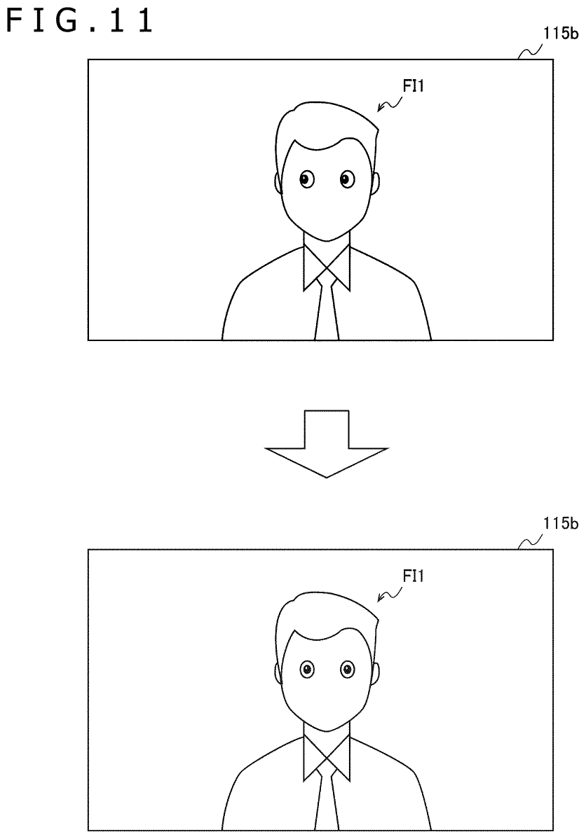

FIG. 11 is a diagram for describing correction of the face image performed by the display control section 140 according to the present embodiment.

An upper stage of FIG. 11 illustrates an example of a case in which the first display area 115 of the display apparatus 10b used by the user U2 displays the face image FI1 of the user U1 with no correction, the face image FI1 being taken by the image taking section 130a in the situation depicted in the upper stage of FIG. 10.

In this case, the face image FI1 displayed by the first display area 115 is likely to give an eye gaze not directed to the front as depicted in the figure.

On the other hand, a lower stage of FIG. 11 depicts the first display area 115 displaying the face image FI1 with the eye gaze corrected by the display control section 140.

The display control section 140 according to the present embodiment may detect the eye gaze with use of various technologies widely used in the field of eye gaze correction.

Note that the eye gaze correction described above may be performed by a display control section 140a of the display apparatus 10a having taken the face image FI1 of the user U1 or a display control section 140b of the display apparatus 10b having received the face image FI1 of the user U1.

### <<1.5. Details of Image Taking Control>>

Now, image taking control according to the present embodiment will be described in detail. According to the present embodiment. The display apparatus 10 according to the present embodiment may further perform image taking control as described below in addition to the display control as described above.

Specifically, the image taking control section 150 according to the present embodiment may perform control to make the position of the eye gaze of the user on the first display area 115 closer to the center of the angle of view of the image taking section 130 taking an image of the face of the user.

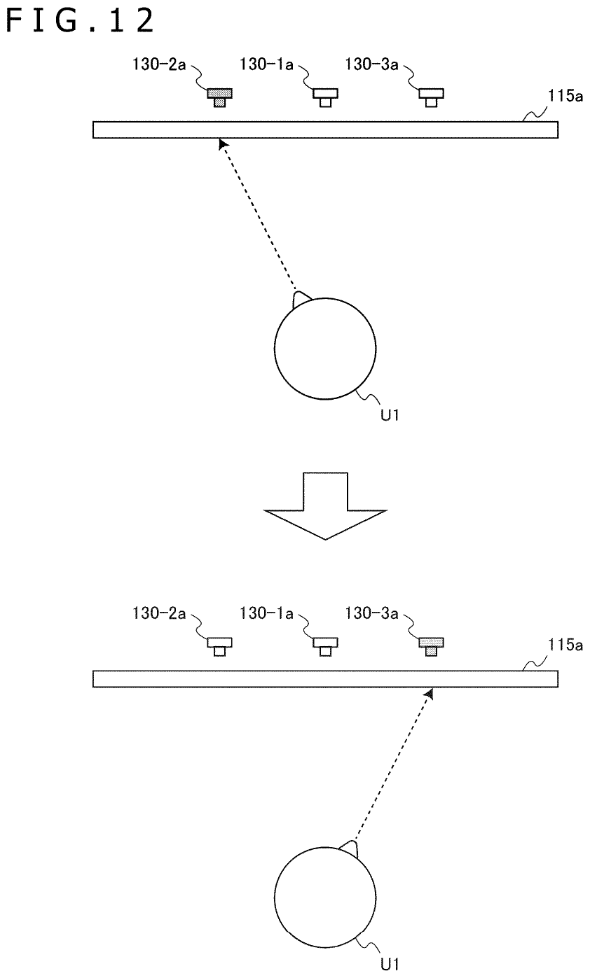

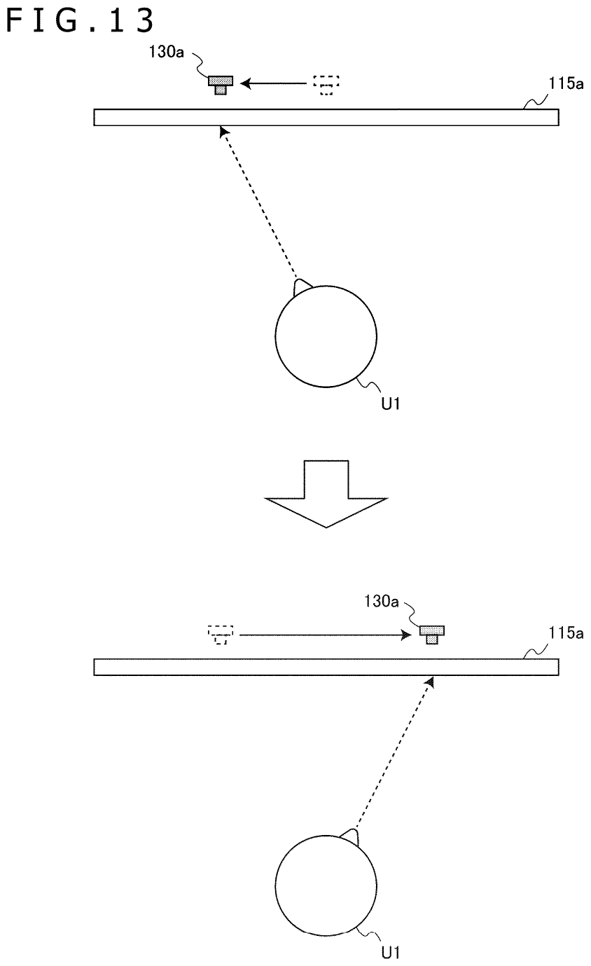

FIGS. 12 and 13 are diagrams for describing image taking control according to the present embodiment.

For example, FIG. 12 depicts the display apparatus 10a including multiple image taking sections 130-1a to 130-3a.

In this case, an image taking control section 150a of the display apparatus 10a may cause, among the multiple image taking sections 130-1a to 130-3a, the image taking section 130a located close to the position of the eye gaze of the user U1 on the first display area 115 to take an image of the face of the user U1.

For example, in a case of an example illustrated in an upper stage of FIG. 12, the image taking section 130-2a is located closest to the position of the eye gaze of the user U1 on the first display area 115a. In this case, the image taking control section 150a causes the image taking section 130-2a to take an image of the face of the user U1.

On the other hand, in an example illustrated in a lower stage of FIG. 12, the image taking section 130-3a is located closest to the position of the eye gaze of the user U1 on the first display area 115a. In this case, the image taking control section 150a causes the image taking section 130-3a to take an image of the face of the user U1.

The control as described above enables, in the separate display apparatus 10b displaying the taken face image FI1 of the user U1, an effective increase in the possibility that the eye gaze of the face image FI1 of the user U1 matches the eye gaze of the user U2 using the display apparatus 10b.

Further, FIG. 13 depicts a case where the display apparatus 10a includes a single image taking section 130a.

In this case, the image taking control section 150a of the display apparatus 10a may move the image taking section 130a to make the position of the eye gaze of the user U1 on the first display area 115a closer to the center of the angle of view of the image taking section 130a taking an image of the face of the user U1.

For example, an upper stage of FIG. 13 illustrates a case where the eye gaze of the user U1 has moved leftward from the vicinity of the center of the first display area 115a as viewed from the user. In this case, the image taking control section 150a of the display apparatus 10a causes the image taking section 130a to move leftward in line with the eye gaze of the user 130a as viewed from the user.

On the other hand, a lower stage of FIG. 13 illustrates a case where the eye gaze of the user U1 in the state as depicted in the upper stage of FIG. 10 has moved rightward as viewed from the user. In this case, the image taking control section 150a of the display apparatus 10a causes the image taking section 130a to move rightward in line with the eye gaze of the user as viewed from the user.

The control as described above enables an effective increase in the possibility of allowing an image catching the eye gaze of the user from the front to be taken.

### <<1.6. Flow of Processing>>

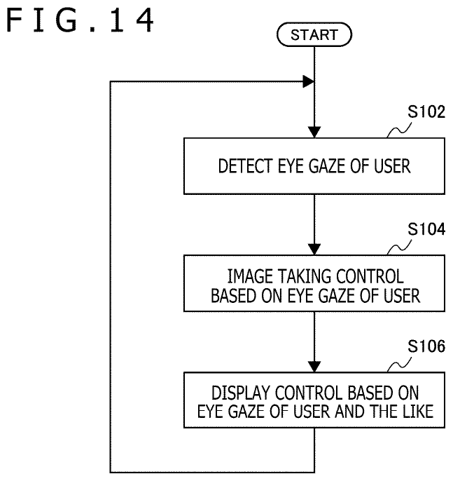

Now, a flow of processing executed by the display apparatus 10 according to the present embodiment will be described with reference to an example. FIG. 14 is a flowchart illustrating an example of the flow of processing executed by the display apparatus 10 according to the present embodiment.

In a case of an example illustrated in FIG. 14, first, the display control section 140 detects the eye gaze of the user U1 facing the first display area 115 (S102).

Then, the image taking control section 150 controls the image taking section 130 in reference to the position of the eye gaze of the user U detected in step S102 to cause the image taking section 130, to take the face image FI1 of the user U1 (S104).

Note that, in a case where the display apparatus 10 is used for the video chat with the separate display apparatus 10, for example, the face image FI1 taken in step S104 is transmitted to the separate display apparatus 10.

Next, the display control section 140 controls the display of the face image FI by the first display area 115 and the display by the second display area 125 in reference to the position of the eye gaze of the user detected in step S102 (S106).

Note that, note that, in the case where the display apparatus 10 is used for the video chat with the separate display apparatus 10, for example, the display control section 140 performs the display control of the face image FI received from the separate display apparatus 10, in step S106.

On the other hand, in a case where the display apparatus 10 is used by the user U1 for selfie taking, video streaming, or the like, the display control section 140 performs the display control for the face image FI1 of the user U1 in step S106.

### <<1.7. Applied Example>>

Now, an applied example of the display apparatus 10 according to the present embodiment will be described.

As an example, the display apparatus 10 according to the present embodiment can be applied to various video chats (communication via images).

The display apparatus 10 can be applied to both 1:1 video charts and N:N video chats, and the intended use is not limited to commercial use or private use.

Examples of the video chat to which the display apparatus 10 according to the present embodiment is applicable widely include, for example, various conferences within a company or between companies, business, support provision, service provision, various interviews, private communication within a family or between friends, lectures, lessons, and the like.

Further, for example, the display apparatus 10 according to the present embodiment is widely applicable to uses intended to take images of the user using the display apparatus 10 and to check taken images. Examples of the use include selfie taking and image taking intended for video streaming.

Further, for example, the display apparatus 10 according to the present embodiment is applicable to various signages. The signage using the display apparatus 10 according to the present embodiment allows an image of the user to be taken by the image taking section 130 disposed behind the first display area 115, while displaying information by the first display area 115, enabling a reduction in relief of stress of the user caused by being monitored.

Further, image taking without being recognized by the person being taken can be applied to various security cameras, entry phones, and the like. For example, in a case where the display apparatus 10 according to the present embodiment is applied to an entry phone, for example, the first display area 115 may be caused to display an animation mimicking a face, eyes, or the like, and the animation may be used to perform interaction with a visitor or the like.

Further, the display apparatus 10 according to the present embodiment is applicable to provision of various services in a commercial facility, a public facility, or the like.

For example, in a play park or the like, in a case where an image taking service using the display apparatus 10 is provided, such control that, for example, a face image of a character is caused to be displayed in the first display area 115 and the shutter is released in a case where the eye gaze of the character substantially matches the eye gaze of the user may be performed.

Further, for example, in a case where the display apparatus 10 according to the present embodiment is used for navigation in a station using the display apparatus 10 according to the present embodiment, or the like, a friendly service can be provided using a character with an eye gaze matching the eye gaze of the user.

### <2. Hardware Configuration Example of Control Apparatus 90>

In the case illustrated in the above-described embodiment, the display apparatus 10 includes the display control section 140 and the image taking control section 150. On the other hand, the control functions of the display control section 140 and the image taking control section 150 may be provided in a separate control apparatus 90. Further, in this case, the control apparatus 90 may control multiple display apparatuses 10 via a network.

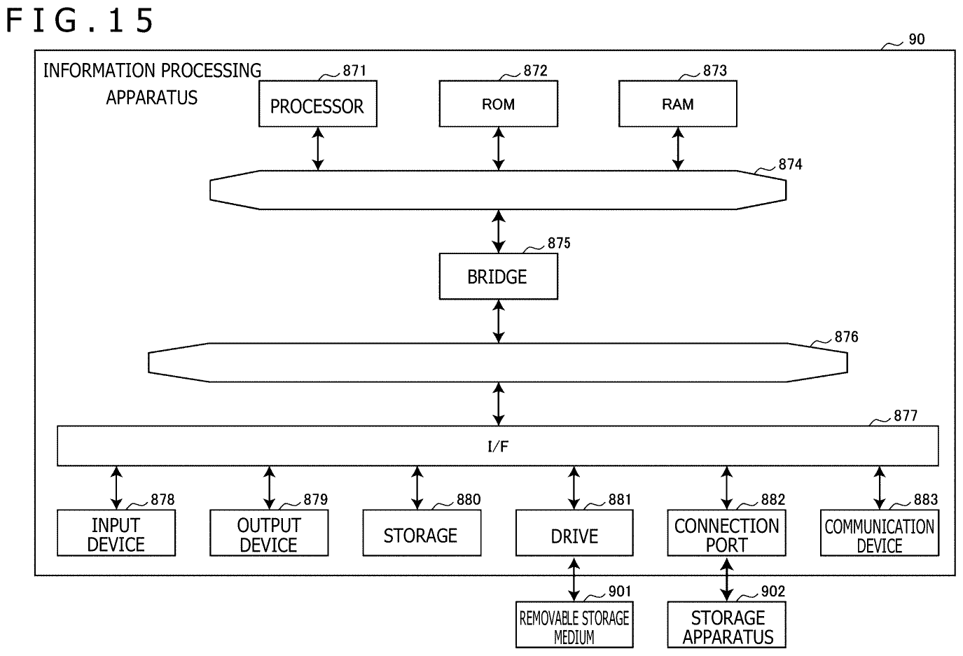

FIG. 15 is a block diagram illustrating a hardware configuration example of the control apparatus 90 according to an embodiment of the present disclosure. The control apparatus 90 includes, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. Note that the hardware configuration illustrated here is merely an example and that some of the components may be omitted. Further, the control apparatus 90 may further include components other than those depicted here.

### (Processor 871)

The processor 871 functions, for example, as an arithmetic processing device or a control device and controls the operations of the components in general or some of the operations thereof according to various programs recorded in the ROM 872, the RAM 873, the storage 880, or a removable storage medium 901.

### (ROM 872, RAM 873)

The ROM 872 is means for storing programs loaded into the processor 871, data used for calculation, and the like. For example, the RAM 873 temporarily or permanently stores programs loaded into the processor 871, various parameters varying as appropriate when the programs are executed, and the like.

### (Host Bus 874, Bridge 875, External Bus 876, Interface 877)

The processor 871, the ROM 872, and the RAM 873 are, for example, connected to each other via the host bus 874 that enables high-speed data transmission. Meanwhile, the host bus 874 is connected via the bridge 875 to the external bus 876, which transmits data at a relatively low speed. Further, the external bus 876 is connected to various components via the interface 877.

### (Input Device 878)

As the input device 878, for example, a mouse, a keyboard, a touch panel, buttons, switches, a lever, or the like is used. Further, as the input device 878, there may be used a remote controller that can transmit control signals utilizing infrared rays or other radio waves. Further, the input device 878 includes a sound input device such as a microphone.

### (Output Device 879)

The output device 879 is, for example, a device that can visually or auditorily notify the user of information acquired, as exemplified by a display device such as a CRT (Cathode Ray Tube), an LCD, or an organic EL, an audio output device such as a speaker or a headphone, a printer, a mobile phone, a facsimile device, or the like. Further, the output device 879 according to the present disclosure includes various vibration devices that can output haptic stimuli.

### (Storage 880)

The storage 880 is a device for storing various kinds of data. As the storage 880, for example, a magnetic storage device such as a hard disk drive (HDD), a semiconductor storage device, an optic storage device, a magneto-optic storage device, or the like is used.

### (Drive 881)

The drive 881 is, for example, a device that reads information recorded in the removable storage medium 901, as exemplified by a magnetic disk, an optical disc, a magneto-optic disc, a semiconductor memory, or the like and that writes information to the removable storage medium 901.

### (Removable Storage Medium 901)

The removable storage medium 901 is any of, for example, DVD media, Blue-ray (registered trademark) media, HD DVD media, various semiconductor storage media, and the like. Of course, the removable storage medium 901 may be, for example, an IC card equipped with a non-contact IC chip, electronic equipment, or the like.

### (Connection Port 882)

The connection port 882 is, for example, a port to which external connection equipment 902 is connected, as exemplified by a USB (Universal Serial Bus) port, an IEEE 1394 port, an SCSI (Small Computer System Interface), an RS-232C port, an optical audio terminal, or the like.

### (External Connection Equipment 902)

The external connection equipment 902 is, for example, a printer, a portable music player, a digital camera, a digital video camera, an IC recorder, or the like.

### (Communication Device 883)

The communication device 883 is, for example, a communication device for connection to the network, as exemplified by a communication card for a wired or wireless LAN, Bluetooth (registered trademark), or a WUSB (Wireless USB), a router for optical communication, a router for ADSL (Asymmetric Digital Subscriber Line), a modem for various types of communication, or the like.

### 3. Conclusion

As described above, the display apparatus 10 according to an embodiment of the present disclosure includes the first display section 110 including the first display area 115 having transparency and the second display section 120 including the second display area 125 disposed in such a manner as to be visible through the first display area 115.

Further, the display apparatus 10 according to an embodiment of the present disclosure includes the image taking section 130 disposed between the first display section 110 and the second display section 120 to enable an image of the user U against the first display area 115 to be taken via the first display area 115.

The above-described configuration enables display of an image catching, from the vicinity of the front surface, the eye gaze of the user closely looking at the display area, with less sense of strangeness.

The preferred embodiment of the present disclosure has been described above in detail with reference to the drawings. However, the technical scope of the present disclosure is not limited to such an example. Obviously, those having ordinary knowledge in the technical field of the present disclosure can arrive at many variations or modifications within the scope of technical ideas recited in the claims, and it is comprehended that these variations or modifications also reasonably belong to the technical scope of the present disclosure.

Further, steps related to the processing described herein need not necessarily chronologically processed along the order described in the flowchart or sequence diagram. For example, the steps related to the processing of each apparatus may be processed in an order different from that described herein or may be processed in parallel.

Further, the series of processing operations performed by each apparatus described herein may be implemented using any of software, hardware, and a combination of software and hardware. For example, programs constituting software are provided inside or outside each apparatus and are preliminarily stored in a non-transitory computer readable medium. Further, each program is loaded into a RAM during execution by a computer, and is executed by various processors, for example. The above-described storage medium is, for example, a magnetic disk, an optical disc, a magneto-optic disc, a flash memory, or the like. Further, the above-described computer program may be delivered, for example, via a network, without use of a storage medium.

Further, the effects described herein are only informative and illustrative and are not restrictive. In other words, in addition to or instead of the above-described effects, the technology according to the present disclosure can produce other effects that are obvious to those skilled in the art from the description herein.

Note that the following configurations also belong to the technical scope of the present disclosure.

(1)

A display apparatus including:
a first display section including a first display area having transparency;
a second display section including a second display area disposed in such a manner as to be visible through the first display area; and
an image taking section disposed between the first display section and the second display section to enable an image of a user facing the first display area to be taken via the first display area.
   (2)

The display apparatus according to (1) above, in which
the image taking section is disposed with a center of an angle of view located near a center of the first display area.
   (3)

The display apparatus according to (1) or (2) above, further including:
a display control section causing a face image to be displayed in the first display area and near a center of an angle of view of the image taking section.
   (4)

The display apparatus according to (3) above, in which the face image includes an image corresponding to a face of a subject communicating with the user via an image.

(5)

The display apparatus according to (4) above, in which the face image is an image of a face of a speaker having a conversation with the user via an image.

(6)

The display apparatus according to (5) above, in which the display control section causes the face image that is included in a plurality of the face images caused to be displayed in the first display area and that depicts a speaker making a speech to be displayed near the center of the angle of view of the image taking section.

(7)

The display apparatus according to (5) or (6) above, in which
the display control section causes the face image that is included in a plurality of the face images caused to be displayed in the first display area and that depicts a speaker making a speech to be highlighted.
   (8)

The display apparatus according to (4) above, in which the face images include an image of a face of the user taken by the image taking section.

(9)

The display apparatus according to any one of (4) through (8) above, in which
the display control section causes the face image to be displayed at a position of an eye gaze of the user on the first display area.
   (10)

The display apparatus according to any one of (4) through (9) above, in which
the display control section corrects the face image to substantially match an eye gaze of the face image with an eye gaze of the user.
   (11)

The display apparatus according to any one of (1) through (10), further including:
an image taking control section that performs control to make a position of an eye gaze of the user on the first display area closer to a center of an angle of view of the image taking section that takes an image of a face of the user.
   (12)

The display apparatus according to (11) above, in which
the image taking control section causes the image taking section to move to make the position of the eye gaze of the user on the first display area closer to the center of the angle of view of the image taking section that takes an image of the face of the user.
   (13)

The display apparatus according to (11) above, in which
the image taking control section causes the image taking section that is included in a plurality of the image taking sections and that is near the position of the eye gaze of the user on the first display area to take an image of the face of the user.
   (14)

The display apparatus according to any one of (1) through (13) above, in which
an image taken by the image taking section is displayed on an apparatus used by a person communicating with the user via the image.
   (15)

The display apparatus according to any one of (1) through (14) above, in which
the second display area has transparency.
   (16)

The display apparatus according to (15) above, in which
the transparency of the second display area is adjustable.
   (17)

The display apparatus according to (1) through 16 above, further including:
a shielding section that shields the image taking section from outside light except for light entering via the first display area.
   (18)

A display control method including:
controlling, by a processor, display of an image by a display apparatus including a first display section including a first display area having transparency, a second display section including a second display area disposed in such a manner as to be visible through the first display area, and an image taking section disposed between the first display section and the second display section to enable an image of a user facing the first display area to be taken via the first display area, in which
controlling the display of the image by the display apparatus further includes causing a face image to be displayed in the first display area and near a center of an angle of view of the image taking section.
   (19)

A program causing a computer to implement:
a display control function for controlling display of an image by a display apparatus including a first display section including a first display area having transparency, a second display section including a second display area disposed in such a manner as to be visible through the first display area, and an image taking section disposed between the first display section and the second display section to enable an image of a user facing the first display area to be taken via the first display area, wherein
the display control function is caused to display a face image in the first display area and near a center of an angle of view of the image taking section.

### REFERENCE SIGNS LIST

10: Display apparatus
110: First display section
115: First display area
120: Second display section
125: Second display area
130: Image taking section
140: Display control section
150: Image taking control section
160: Shielding section

1. A display apparatus comprising:
a first display section including a first display area having transparency;
a second display section including a second display area disposed in such a manner as to be visible through the first display area; and
an image taking section disposed between the first display section and the second display section to enable an image of a user facing the first display area to be taken via the first display area.

2. The display apparatus according to claim 1, wherein
the image taking section is disposed with a center of an angle of view located near a center of the first display area.

3. The display apparatus according to claim 1, further comprising:
a display control section causing a face image to be displayed in the first display area and near a center of an angle of view of the image taking section.

4. The display apparatus according to claim 3, wherein
the face image includes an image corresponding to a face of a subject communicating with the user via an image.

5. The display apparatus according to claim 4, wherein
the face image is an image of a face of a speaker having a conversation with the user via an image.

6. The display apparatus according to claim 5, wherein
the display control section causes the face image that is included in a plurality of the face images caused to be displayed in the first display area and that depicts a speaker making a speech to be displayed near the center of the angle of view of the image taking section.

7. The display apparatus according to claim 5, wherein
the display control section causes the face image that is included in a plurality of the face images caused to be displayed in the first display area and that depicts a speaker making a speech to be highlighted.

8. The display apparatus according to claim 4, wherein
the face images include an image of a face of the user taken by the image taking section.

9. The display apparatus according to claim 4, wherein
the display control section causes the face image to be displayed at a position of an eye gaze of the user on the first display area.

10. The display apparatus according to claim 4, wherein
the display control section corrects the face image to substantially match an eye gaze of the face image with an eye gaze of the user.

11. The display apparatus according to claim 1, further comprising:
an image taking control section that performs control to make a position of an eye gaze of the user on the first display area closer to a center of an angle of view of the image taking section that takes an image of a face of the user.

12. The display apparatus according to claim 11, wherein
the image taking control section causes the image taking section to move to make the position of the eye gaze of the user on the first display area closer to the center of the angle of view of the image taking section that takes an image of the face of the user.

13. The display apparatus according to claim 11, wherein
the image taking control section causes the image taking section that is included in a plurality of the image taking sections and that is near the position of the eye gaze of the user on the first display area to take an image of the face of the user.

14. The display apparatus according to claim 1, wherein
an image taken by the image taking section is displayed on an apparatus used by a person communicating with the user via the image.

15. The display apparatus according to claim 1, wherein
the second display area has transparency.

16. The display apparatus according to claim 15, wherein
the transparency of the second display area is adjustable.

17. The display apparatus according to claim 1, further comprising:
a shielding section that shields the image taking section from outside light except for light entering via the first display area.

18. A display control method comprising:
controlling, by a processor, display of an image by a display apparatus including a first display section including a first display area having transparency, a second display section including a second display area disposed in such a manner as to be visible through the first display area, and an image taking section disposed between the first display section and the second display section to enable an image of a user facing the first display area to be taken via the first display area, wherein
controlling the display of the image by the display apparatus further includes causing a face image to be displayed in the first display area and near a center of an angle of view of the image taking section.

19. A program causing a computer to implement:
a display control function for controlling display of an image by a display apparatus including a first display section including a first display area having transparency, a second display section including a second display area disposed in such a manner as to be visible through the first display area, and an image taking section disposed between the first display section and the second display section to enable an image of a user facing the first display area to be taken via the first display area, wherein
the display control function is caused to display a face image in the first display area and near a center of an angle of view of the image taking section.
